(19) United States
(12) Patent Application Publication
(10) Pub. No.: US 2018/0034847 A1
(43) Pub. Date: Feb. 1, 2018

(54) REGENERATION AND GENERATIONAL MUTATION FOR SECURITY AND FIDELITY IN SOFTWARE DEFINED NETWORKS

(71) Applicant: FUGUE, INC., Frederick, MD (US)

(72) Inventor: Josha STELLA, Shepherdstown, WV (US)

(73) Assignee: FUGUE, INC., Frederick, MD (US)

(21) Appl. No.: 15/661,904

(22) Filed: Jul. 27, 2017

Related U.S. Application Data
(60) Provisional application No. 62/367,429, filed on Jul. 27, 2016.

(51) Int. Cl. H04L 29/06; H04L 12/24

(52) U.S. Cl. CPC H04L 63/1441; H04L 41/0806; H04L 41/12; H04L 63/1408

(57) ABSTRACT

Techniques for replacing instances of software defined networks (SDN's) in software defined network systems (SDN systems) are provided. In a SDN system having a first instance of a SDN, a second instance of the SDN is instantiated, and instructions are sent to other components of the SDN system to route traffic to the new SDN instance, and the old SDN instance is retired from service. Instructions for routing traffic to the new SDN instance and for retiring the old SDN instance may be transmitted by a distributed key/value store system leveraging asynchronous communication. A retired SDN instance may be destroyed or repurposed for deceptive or forensic purposes. SDN infrastructure and topology may be cycled according to a schedule, may be algorithmically cycled, and may be proactively cycled without any indication that an SDN instance is compromised. Similar techniques for replacing instances of individual network components in SDN's are also provided.

### CROSS-REFERENCE TO RELATED APPLICATION

This application claims the benefit of U.S. Provisional Application No. 62/367,429, filed on Jul. 27, 2016, the entire contents of which are incorporated herein by reference.

### FIELD OF THE INVENTION

This disclosure relates generally to distributed computing systems and to software defined networks.

### BACKGROUND OF THE INVENTION

Cloud computing allows individuals, businesses, and other organizations to implement and run large and complex computing environments without having to invest in the physical hardware (such as a server or local computer) necessary to maintain such environments. Rather than having to keep and maintain physical machines that perform the tasks associated with the desired computing environment, an end-user can instead “outsource” the computing to a computing “cloud” that can implement the desired computing environment in a remote location. The cloud can consist of a network of remote servers hosted on the internet that are shared by numerous end-users to implement each of their desired computing needs. Simplifying the process to build, optimize, and maintain computing environments on the cloud can lead to a positive end-user experience. Allowing a user to develop a robust computing infrastructure on the cloud, while seamlessly optimizing and maintaining it, can minimize frustrations associated with corrupted infrastructure that can occur during the course of operating a computing environment on the cloud.

The development of cloud computing and virtualization technology has also given rise to software defined networking (SDN) technology. Software defined networks (SDN's) operate, in part, by separating traffic control functionality from network hardware. For example, network administrators of a SDN may exercise central control over packet flow from a central controller, rather than having packet flow decisions determined entirely by switch firmware. The control plane and the data plane in software defined networks may thus be disassociated from one another. Among other advantages, SDN's provide additional flexibility and versatility over traditional networks, and may allow for more seamless interaction with and leveraging of distributed resources made available through public cloud infrastructure.

### SUMMARY OF THE INVENTION

There is a need for security and fidelity solutions that leverage the unique capabilities of cloud computing infrastructures and SDN's in order to provide improved security and fidelity for cloud computing environments and SDN's. Provided herein are solutions and techniques that involve the application of regeneration and generational mutation technology to SDN components—such as gateways, routing tables, subnets, etc.—and to SDN's in their entirety, in order to improve security and fidelity.

Because infrastructure resources are subservient to the goals of the system in cloud computing, and because they are ephemeral and low cost, regeneration of resources can be leveraged to iteratively replace components of a system, providing new and known-good components at a relatively high frequency. In cloud computing environments, it is possible to leverage “regeneration” of virtual compute components in order to improve security. As explained, for example, in U.S. Pat. No. 9,003,372, titled “SYSTEM AND METHOD FOR REPLACING SOFTWARE COMPONENTS WITH CORRESPONDING KNOWN-GOOD SOFTWARE COMPONENTS WITHOUT REGARD TO WHETHER THE SOFTWARE COMPONENTS HAVE BEEN COMPROMISED OR POTENTIALLY COMPROMISED,” the entirety of which is hereby incorporated by reference, new “known-good” software components that have not yet been made available in a runtime environment may be used to replace existing, run-time software components, and to perform at least some of the functions performed by the existing software component. In its most basic forms, regeneration and generational mutation may have profound effects on the hardness of a system to intrusion over time. For example, cycling compute resources (e.g., replacing EC2 instances in the same AMAZON MACHINE IMAGE) over time may effectively obstruct low/slow attacks and intrusions that rely upon a chain of compromised resources. As explained herein, regeneration and generational mutation of entire SDN's may further improve security and fidelity of cloud computing systems.

Additionally, variability of timing, surface, and resource components in cloud computing systems may be implemented using algorithms and situational awareness in order to produce cloud systems that are difficult to compromise, and that create traps for an intruder that may be non-obvious. This may improve the ability to identify and collect information on attempted intrusions and intruders.

As described below, it is possible in SDN environments to generate a second instance of an entire SDN, according to a predetermined timing schedule or according to an adaptive algorithm, and to migrate traffic to the new instance and retire the old instance. Alternately or additionally, it is possible to replace underlying components of a SDN—such as subnets, routing tables, gateways, and the like—by bringing new instances of components of the network into production over time. Alternatively or additionally, new instances of SDN's (in their entirety) or new instances of SDN components may be created and brought into production to replace prior instances, where the new instances have equivalent or similar infrastructure from a functional perspective (e.g., they may provide the same compute and storage resources and appear identical or similar to an end user and/or to a network administrator), but where the new instance has a distinct topology in subnet and service location from the previous instance; this concept may be referred to as generational mutation of an SDN, and it may be carried out in accordance with a predefined schedule or in accordance with an adaptive algorithm. In some embodiments, as old instances of SDN's or SDN components are retired from service, they may remain online and may be maintained as deceptive and/or forensic resources, such as honey-pots or trip-wires; as legitimate traffic is migrated away from old instances and to new instances, network administrators may infer that traffic thereafter active through old instances is malicious, unauthorized, or inadvertent traffic.

In some embodiments, a method for replacing one or more instances in a software defined network system comprises: in a software defined network system having a first instance of a software defined network, in response to one or more trigger conditions being satisfied: instantiating a second instance of the software defined network; transmitting instructions to one or more components of the software defined network system to route traffic to infrastructure of the second instance of the software defined network; and retiring the first instance of the logical software defined network from service.

In some embodiments of the method, the second instance of the software defined network comprises a same compute and storage infrastructure as the first instance.

In some embodiments of the method, the second instance of the software defined network comprises a same topology as the first instance.

In some embodiments of the method, the second instance of the software defined network comprises distinct compute and storage infrastructure from the first instance, wherein the distinct compute and storage infrastructure are configured to fulfill an equivalent functional requirement as the first instance.

In some embodiments of the method, the distinct compute and storage infrastructure are selected so as to be resistant to exploits targeting infrastructure of the first instance.

In some embodiments of the method, the second instance of the software defined network comprises a distinct topology from the first instance, wherein the distinct topology is configured to fulfill an equivalent functional requirement as the first instance.

In some embodiments of the method, the distinct topology is algorithmically generated to comprise one or more of obfuscated routes, dead ends, and deceptive resources.

In some embodiments of the method, the distinct topology is algorithmically generated such that, from any single exploitable machine in the software defined network system, the majority of visible resources are deceptive resources.

In some embodiments of the method, transmitting instructions to one or more components of the software defined network system comprises transmitting instructions to authorized end users of the software defined network system.

In some embodiments of the method, transmitting instructions to one or more components of the software defined network system comprises transmitting instructions to a second network of the software defined network system.

In some embodiments of the method, transmitting instructions to one or more components of the software defined network system comprises distributing the instructions via a distributed key/value store system.

In some embodiments of the method, the distributed key/value store system uses one or more asynchronous messaging protocols.

In some embodiments of the method, retiring the first instance comprises destroying the first instance.

In some embodiments of the method, retiring the first instance comprises configuring the first instance to serve purpose other than a primary business function.

In some embodiments of the method, the purpose other than a primary business function is one of a deceptive use and a forensic use.

In some embodiments of the method, retiring the first instance comprises transmitting second instructions to one or more components of the software defined network system indicating that the first instance is being retired.

In some embodiments of the method, transmitting the second instructions comprises distributing the instructions via a distributed key/value store system.

In some embodiments of the method, the second instructions comprise an indication that the first instance should be treated by other components of the software defined network system as one of a deceptive resource and a forensic resource.

In some embodiments of the method, the one or more trigger conditions comprises a predefined time being reached.

In some embodiments of the method, the one or more trigger conditions comprises a time-to-live of the first instance of the software defined network expiring.

In some embodiments of the method, the one or more trigger conditions comprises a randomly-generated time-period expiring.

In some embodiments of the method, the one or more trigger conditions are satisfied without receiving any indication that the first instance of the software defined network has been compromised.

In some embodiments, the method further comprises disabling one or more administrative functions for the software defined network system.

In some embodiments, a non-transitory computer-readable storage medium stores instructions that, when executed by a processor of a software defined network system having a first instance of a software defined network, cause the system to: in response to one or more trigger conditions being satisfied: instantiate a second instance of the software defined network; transmit instructions to one or more components of the software defined network system to route traffic to infrastructure of the second instance of the software defined network; and retire the first instance of the logical software defined network from service.

In some embodiments, a software defined network system comprises: a first instance of a software defined network; a processor; and memory storing instructions that, when executed by the processor, cause the system to: in response to one or more trigger conditions being satisfied: instantiate a second instance of the software defined network; transmit instructions to one or more components of the software defined network system to route traffic to infrastructure of the second instance of the software defined network; and retire the first instance of the logical software defined network from service.

In some embodiments, a method for replacing one or more instances in a software defined network system comprises: in a software defined network having a first instance of a network component, in response to one or more trigger conditions being satisfied: instantiating a second instance of the first network component; transmitting instructions to one or more components of the software defined network system to route traffic to the second instance of the network component; and retiring the first instance of the network component from service.

In some embodiments of the method, the network component is a subnet.

In some embodiments of the method, the second instance of the network component comprises a same compute and storage infrastructure as the first instance.

In some embodiments of the method, the second instance of the network component comprises a same topology as the first instance.

In some embodiments of the method, the second instance of the network component comprises distinct compute and storage infrastructure from the first instance, wherein the distinct compute and storage infrastructure are configured to fulfill an equivalent functional requirement as the first instance.

In some embodiments of the method, the distinct compute and storage infrastructure are selected so as to be resistant to exploits targeting infrastructure of the first instance.

In some embodiments of the method, the second instance of the network component comprises a distinct topology from the first instance, wherein the distinct topology is configured to fulfill an equivalent functional requirement as the first instance.

In some embodiments of the method, the distinct topology is algorithmically generated to comprise one or more of obfuscated routes, dead ends, and deceptive resources.

In some embodiments of the method, the distinct topology is algorithmically generated such that, from any single exploitable machine in the software defined network system, the majority of visible resources are deceptive resources.

In some embodiments of the method, transmitting instructions to one or more components of the software defined network system comprises transmitting instructions to authorized end users of the software defined network.

In some embodiments of the method, transmitting instructions to one or more components of the software defined network system comprises transmitting instructions to a second network component of the software defined network.

In some embodiments of the method, transmitting instructions to one or more components of the software defined network system comprises distributing the instructions via a distributed key/value store system.

In some embodiments of the method, the distributed key/value store system uses one or more asynchronous messaging protocols.

In some embodiments of the method, retiring the first instance comprises destroying the first instance.

In some embodiments of the method, retiring the first instance comprises configuring the first instance to serve purpose other than a primary business function.

In some embodiments of the method, the purpose other than a primary business function is one of a deceptive use and a forensic use.

In some embodiments of the method, retiring the first instance comprises transmitting second instructions to one or more components of the software defined network system indicating that the first instance is being retired.

In some embodiments of the method, transmitting the second instructions comprises distributing the instructions via a distributed key/value store system.

In some embodiments of the method, the second instructions comprise an indication that the first instance should be treated by other components of the software defined network system as one of a deceptive resource and a forensic resource.

In some embodiments of the method, the one or more trigger conditions comprises a predefined time being reached.

In some embodiments of the method, the one or more trigger conditions comprises a time-to-live of the first instance of the software defined network expiring.

In some embodiments of the method, the one or more trigger conditions comprises a randomly-generated time-period expiring.

In some embodiments of the method, the one or more trigger conditions are satisfied without receiving any indication that the first instance of the network component has been compromised.

In some embodiments, the method further comprises disabling one or more administrative functions for the software defined network system.

In some embodiments, a non-transitory computer-readable storage medium stores instructions that, when executed by a processor of a software defined network system having a first instance of a network component, cause the system to: in response to one or more trigger conditions being satisfied: instantiate a second instance of the first network component; transmit instructions to one or more components of the software defined network system to route traffic to the second instance of the network component; and retire the first instance of the network component from service.

In some embodiments, a software defined network system comprises: a first instance of a network component; a processor; and memory storing instructions that, when executed by the processor, cause the system to: in response to one or more trigger conditions being satisfied: instantiate a second instance of the first network component; transmit instructions to one or more components of the software defined network system to route traffic to the second instance of the network component; and retire the first instance of the network component from service.

In some embodiments, one or more of the limitations discussed above with respect to one or both of the methods may be similarly applicable to one or more of the systems or computer-readable storage mediums.

### BRIEF DESCRIPTION OF THE DRAWINGS

FIG. 1 illustrates an exemplary cloud computing environment in accordance with some embodiments.

FIG. 2 illustrates an exemplary software defined networking system, for replacement/regeneration of a software defined network, in accordance with some embodiments.

FIG. 3 is a flowchart showing method 300, which is an exemplary process for replacing or regenerating a software defined network.

FIG. 4 illustrates an exemplary software defined networking system, for replacement/regeneration of software defined networking components, in accordance with some embodiments.

FIG. 5 is a flowchart showing method 300, which is an exemplary process for replacing or regenerating sets of network components in a software defined network.

FIG. 6 illustrates an exemplary software defined networking system, for generational mutation of a software defined network, in accordance with some embodiments.

### DETAILED DESCRIPTION OF THE INVENTION

A cloud computing system (“cloud”) is a large distributed computer system that is shared by multiple clients and is used to virtualize computing environments, thereby liberating end-users from the burdens of having to build and maintain physical information technology infrastructure at a local site. These systems also allow users to quickly scale up and down based on their current computing needs.

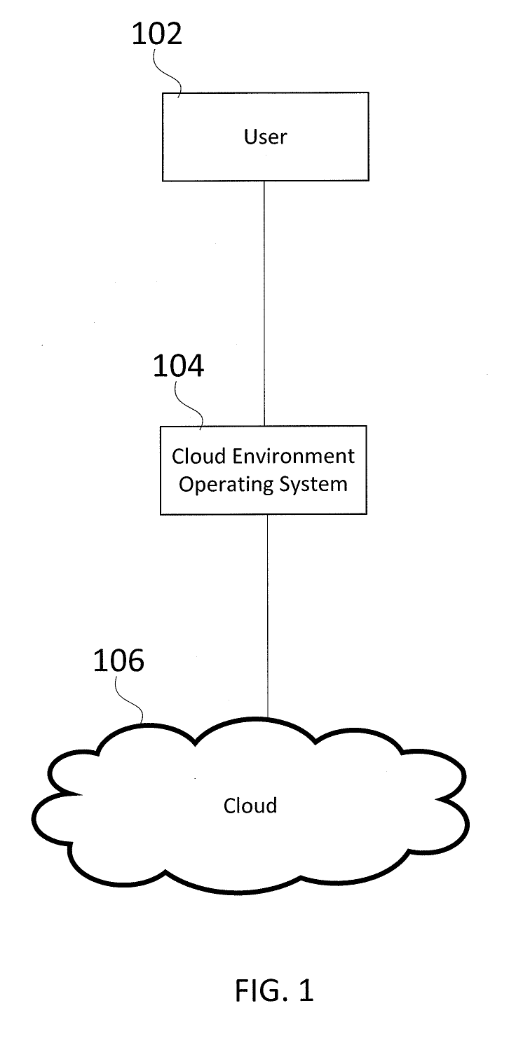

FIG. 1 illustrates an exemplary cloud computing environment according to examples of the disclosure. The cloud computing environment depicted in FIG. 1 comprises user 102, who may wish to implement a computing environment on a cloud 106. Examples of users 100 can include individuals, businesses, or other organizations that wish to utilize the distributed computing system provided by the cloud to implement a computing environment such as a web server, a computer network, a computer database operation, etc.

The cloud 106, as previously discussed, is one or more distributed generalized computers that provide the computing resources to a user to allow them to implement their desired computing environment. Commercial cloud computing services such as AMAZON WEB SERVICES, MICROSOFT AZURE, GOOGLE CLOUD PLATFORM, are examples of distributed computer networks (clouds) available to users (for a fee) and allow them to build and host applications and websites, store and analyze data, among other uses. Clouds are scalable, meaning that the computing resources of the cloud can be increased or decreased based on the real-time needs of a particular user. In one example, a cloud 104 can be utilized to implement a website run by a user 102. The cloud 106 can maintain and operate a web-server based on the specifications defined by the user 102. As web-traffic to the website increases, the cloud can increase the computing resources dedicated to the website to match the surge in traffic. When web traffic is sparse, the cloud 106 can decrease the computing resources dedicated to the website to match the decrease in traffic.

A cloud environment operating system (OS) 104 can help to facilitate the interaction between a user 102 and a cloud computing environment 106. A conventional operating system manages the resources and services of a single computer. In contrast, a cloud environment operating system may manage the resources and services of a cloud environment.

A cloud environment operating system can automate the creation and operation of one or more cloud infrastructures and can create and destroy computing instances on one or more cloud service providers. While the example of FIG. 1 illustrates the cloud environment OS as a stand-alone entity, the example should not be considered limiting. The cloud environment OS can be run on a client device, on a server such as a third party server, or located on a cloud service provider system that runs and executes the computing environment. The cloud environment OS operates separately and interfaces with the cloud computing environment including any command line interfaces or operating systems used by the cloud to build and maintain the computing infrastructure.

A cloud environment operating system 104 can interface with a user 102 by allowing the user to specify a desired computing infrastructure in a simplified and concise manner. In one example, a user 102 can specify a computing environment using a programming language designed to interface with the cloud environment OS 104.

As may be particularly relevant to the exemplary embodiments and techniques discussed below, a cloud environment operating system may define and implement a SDN by specifying and causing the instantiation of various virtual networking components, such as servers, gateways, subnets, etc. A cloud environment operating system may instantiate new instances of various SDN components, may retire existing instances of SDN components, or may alter the configuration of existing SDN components (such as to change its address/location or change its role in the SDN). As used herein, a component of an SDN may refer to a resource or element of the SDN itself, such as a compute resource, a storage resource, a web server, a subnet, a routing tables, a gateway, or the like. A component of an SDN may also be termed a network component. As used herein, a component of a SDN system may refer to a component of an SDN as explained above, and may also refer to a user, controller, machine, instance, device, or network that is considered to be outside the scope of the SDN, but which may still interact with the SDN; thus, an end-user accessing a public-cloud-hosted SDN from a laptop may be considered to be part of an SDN system, though neither the user nor the user's laptop may be considered to be part of the SDN itself.

### SDN Regeneration/Replacement

In some embodiments of a SDN system, an underlying network for a system may be replicated while leaving the original version of the network in place. The business function of the system may then be preserved by moving active, legitimate users of the system to the new instance of the network, and retiring the old network. This rollover of users may be accomplished by changes to DNS record pointers, a distributed service discovery mechanism, or other methods.

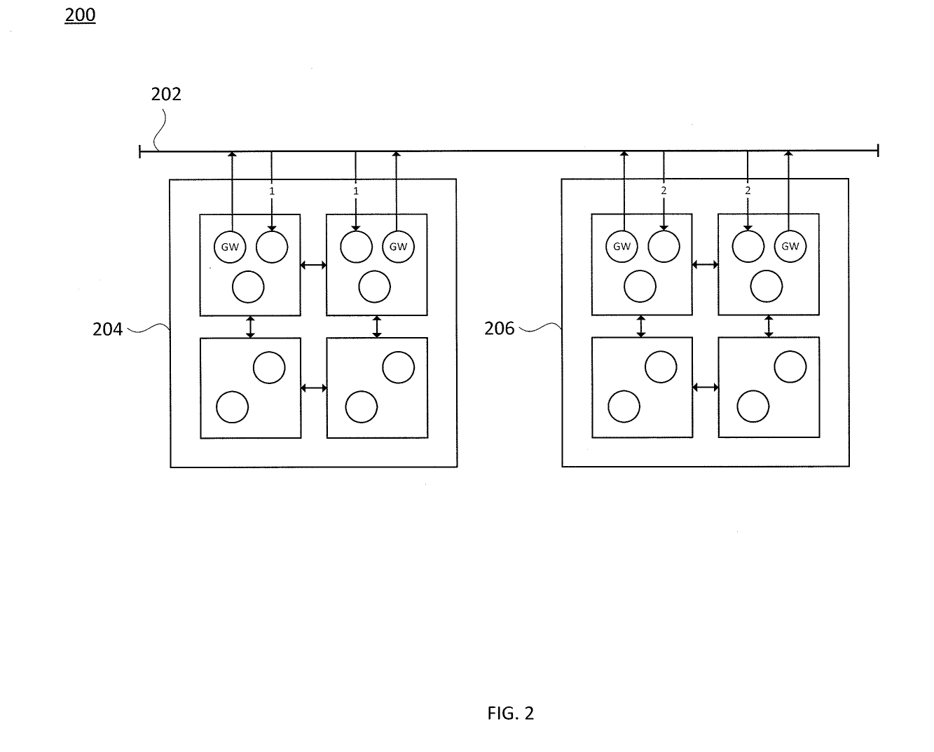

FIG. 2 illustrates an exemplary software defined networking system 200, for replacement/regeneration of a software defined network, in accordance with some embodiments. SDN system 200 may be a part of a cloud environment that may be controlled by a cloud environment operating system, such as cloud environment OS 104 discussed above with reference to FIG. 1.

As shown in FIG. 2, SDN system 200 includes network communication interface 202, which in some instances may be the Internet, or any other suitable public or private network communication interface. The other components of SDN system 200 may communicate with one another, and with other local and remote network components (not depicted), including a cloud environment operating system, via network communication interface 202.

SDN system 200 further includes (at the point in time depicted in FIG. 2) SDN network instance 204. SDN network instance 204 may be any complete SDN, such as a complete virtual private cloud that includes inbound DNS to components (as depicted by arrows from network communication interface 202 to the components of SDN instance 204) and outbound connections through gateways (as depicted by arrows from elements of SDN instance 204 labeled “GW” to network communication interface 202).

SDN system 200 further includes (at the point in time depicted in FIG. 2) SDN network instance 206. SDN instance 206 may share some or all of the attributes of SDN instance 204, as described above. In some embodiments, SDN instance 206 may have identical or substantially identical components, elements, network topology, routing tables, compute resources, storage resources, and/or configuration as SDN instance 204. In some embodiments, SDN instance 206 may have different address information than SDN instance 204.

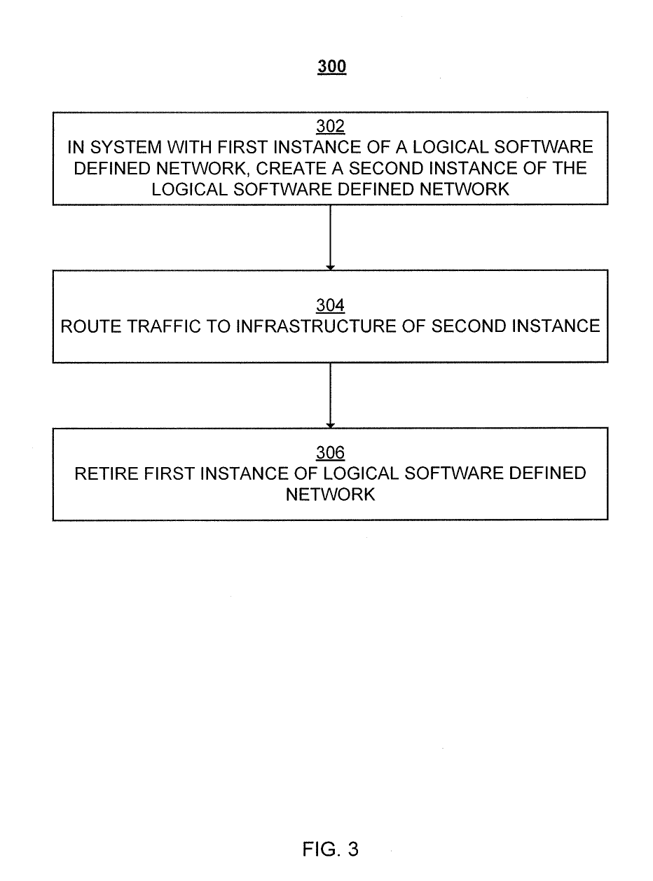

In some embodiments, as explained in further detail below with reference to FIG. 3, instance 204 and instance 206 of SDN system 200 may be brought out of and into service to achieve a replacement (which may also be called a regeneration) of a SDN.

FIG. 3 is a flowchart showing method 300, which is an exemplary process for replacing or regenerating a software defined network. In some embodiments, method 300 may be performed at and/or by a SDN system such as SDN system 200.

At step 302, in some embodiments, in a system with a first instance of a logical software defined network, a second instance of the logical software defined network is created. For example, a network system may include a first instance of a SDN, such as SDN system 200 containing SDN instance 204. The system may thereafter create a second instance of the software defined network, such as SDN system 200 creating SDN instance 206. The second instance may be created to replace the entire logical network. For example, in the case of AMAZON WEB SERVICES (AWS), a new Virtual Private Cloud (VPC) is created, and new compute and other resources are instantiated into the new VPC. The creation of a second SDN instance may also be performed on cloud services aside from AWS; in other systems, a new virtual private cloud environment may be created, and resources and components of the SDN may be instantiated into the new virtual private cloud.

At step 304, in some embodiments, traffic is routed to infrastructure of the second instance. In some embodiments, once the infrastructure of the second instance is instantiated, traffic may be routed to the infrastructure of the second instance. For example, if the second instance is created in a VPC on AWS, then once the new VPC is online, routes and DNS records may be migrated to the second instance. Traffic may be migrated to the second instance, in some embodiments, by utilizing a side-channel to communicate information to components generating traffic that is necessary for the components to learn of the new instance and be able to route traffic to the location of the new instance.

In some embodiments, legitimate traffic, active traffic, and/or legitimate user may be migrated to the second instance through the use of a secure and/or secret communication channel known to active and/or legitimate users of the system. In some embodiments, this communication channel may be referred to as a “soft channel” or “side channel.” Generally speaking, the soft channel may be used to alert legitimate users of the existence, location (e.g., network space), and configuration of the second instance of the SDN; and to instruct those users to route all future traffic to the second instance, or to begin route all traffic there at a specified future time.

In some embodiments, a distributed key/value store system may be used as a “soft channel” to alert legitimate and/or active users of a system to route traffic to a new SDN instance, and to send configuration information, update information, authentication information, encryption keys, and other information necessary to affect an instance regeneration/replacement. Various examples of distributed key/value store systems are described in U.S. Provisional Patent Application No. 62/363,803, filed Jul. 18, 2016, titled “DISTRIBUTED KEY/VALUE STORE SYSTEM USING ASYNCHRONOUS MESSAGING SYSTEMS,” the entirety of which is hereby incorporated by reference. In some embodiments, for example, a distributed key/value store system may be configured such that stored values (e.g., values stored in a central database) may be efficiently distributed/published to one or more of a plurality of nodes/instances of the distributed key/value store system. For example, each instance may subscribe to a common topic of an asynchronous messaging system, such that each instance may listen for updates provided via the topic. A message containing a configuration update may be provided to the topic, and each instance may thereby read the update and be provided with new configuration information. The new configuration information may provide information about the existence, location, and configuration of a new instance of an SDN in a SDN system with which the distributed key/value store system is associated, and the new configuration information may further provide instructions for migrating traffic to the new instance of the SDN.

After receiving the update through the distributed key/value store system, users of the SDN system may store (e.g., cache) the configuration information locally and then continue to listen for subsequent updates. In some embodiments, a distributed key/value store system may allow various users associated with nodes/instances of the distributed key/value store system to publish updates to the entire fleet of subscribed users by (if authorized) sending new configuration data to a central controller for the distributed key/value store system, such that the data will be stored in the central database and then published to each of the nodes of the distributed key/value store system. In this manner, network administrators may send configuration updates and affect SDN instance migrations via more than one client device.

At step 306, in some embodiments, the first instance of the logical software defined network is retired. In the example of system 200 in FIG. 2, SDN instance 206 may be retired from service. In some embodiments, once all legitimate traffic has been routed to the second instance (or once instructions or configurations have been provided to route all legitimate traffic to the second instance), the first instance may be retired by being removed from service entirely, such that the first instance ceases to exist. In some embodiments, a first instance may be retired and may cease to exist when a user of a cloud computing system relinquishes control of the instance; compute resources, storage resources, or other cloud computing resources may be retired or destroyed in this manner by erasing configuration information and other stored data from the resource and by allowing the resource to be repurposed by the cloud computing system for an unrelated purpose, such that the resource may be understood to no longer be a part of the SDN or the SDN system. In some embodiments, this may be referred to as destroying the instance.

In some embodiments, rather than destroying the instance by removing the instance from service entirely, the first instance may be repurposed within a SDN system for forensic and/or deceptive purposes. For example, some or all components of the first instance may be allowed to remain active in the same network address space, but their legitimate business operational purposes may cease. Sensitive data or information may be removed from storage resources of the first instance, and it may optionally be replaced with dummy data. By allowing some or all components of the first instance to remain active in the same network address space, the first instance may serve as a honey-pot or as a trip-wire, such that traffic routed to the first instance following the migration of all legitimate traffic to the second instance may be monitored and analyzed. In some embodiments, the mere existence of the first instance may serve to distract intruders from the second instance. In some embodiments, a network administrator (or an automated system within a SDN system) may assume that, following the migration of all legitimate traffic to the second instance, traffic routed to the first instance is malicious, unauthorized, and/or attributable to an error in configuration of the SDN system. System administrators may monitor and analyze traffic to the first instance in order to identify and analyze malicious traffic, in order to counter-attack intruders, or in order to identify and correct network configuration errors causing traffic to be routed to the first instance after the attempted migration of all legitimate traffic to the second instance.

In a similar manner as discussed above with respect to using a distributed key/value store system to alert users of a SDN to the existence and location of a new instance of the SDN, a distributed key/value store system may also be used to send configuration data and/or instructions to various components of SDN instances themselves. For example, if SDN instances or SDN components themselves are configured to listen for messages distributed through a common topic of an asynchronous messaging system of a distributed key/value store system, then messages may be sent that include new SDN configuration information, such as whether and when to instantiate and bring online components of SDN architecture; whether and when to retire components of SDN architecture; and whether, when, and how to configure components of SDN architecture such that they serve legitimate business or operational functions, forensic functions, and/or deceptive functions.

In some embodiments, method 300 may be iterated or repeated one or more times, including by repeating the method in accordance with a predefined schedule, at predefined times (e.g., hourly, daily, weekly, etc.), at randomly or pseudo-randomly determined times, or in accordance with a time-to-live frequency (e.g., in which an SDN instance is assigned an amount of time after which is should be replaced). In some embodiments, regeneration may be spread across multiple network locations, with integration of resources enabled by encrypted service discovery (e.g., by a distributed key/value store system, or by any other suitable side-channel for discovering and distributing information and configuration regarding SDN system infrastructure and topology).

In some embodiments, a SDN system, such as SDN system 200, may automatically initiate method 300 in accordance with a trigger condition being met; the trigger condition may be based upon a scheduled time being reached, a time-to-live expiring, malicious network activity being detected, or any other network characteristic being measured and satisfying predetermined or dynamically/adaptively determined trigger conditions.

In some embodiments, a software defined network system may monitor for low levels of network activity, and may responsively trigger regeneration or replacement at a time when there will be limited performance impact due to the low levels of network activity. In some embodiments, changing costs for variably priced resources may also trigger regeneration or replacement (e.g., spot market prices for particular instances, in particular regions, and on particular cloud service providers may be monitored, and a SDN system may regenerate or replace a network or component in response to detecting low price levels or other pricing anomalies or activity). Other trigger conditions could include a condition relating to a location from which traffic is being routed to an SDN or component; for example, in order to reduce latencies, networks or components may be replaced or regenerated (including being mutated, as discussed below) based on a location of one or more sources of network traffic. Furthermore, a trigger condition could relate to a desire or need arising to deceptively create the impression that a system includes many actors rather than a single actor; in response to such a need arising, a SDN system may responsively regenerate or replace or mutate networks or components, for example, in order to move networks and resources to different parts of the world or IP addresses to limit traceability on outbound traffic.

In some embodiments, regeneration or replacement of an SDN may be undertaken without receiving any indication that security of an existing instance of the SDN has been compromised.

### SDN Component Regeneration/Replacement

In some embodiments of a SDN system, the underlying logical network may be left in place, but the sub-components of that network—such as subnets, routing tables, etc.—may be replaced. In this model, portions of the system may be brought into production from instantiation over time.

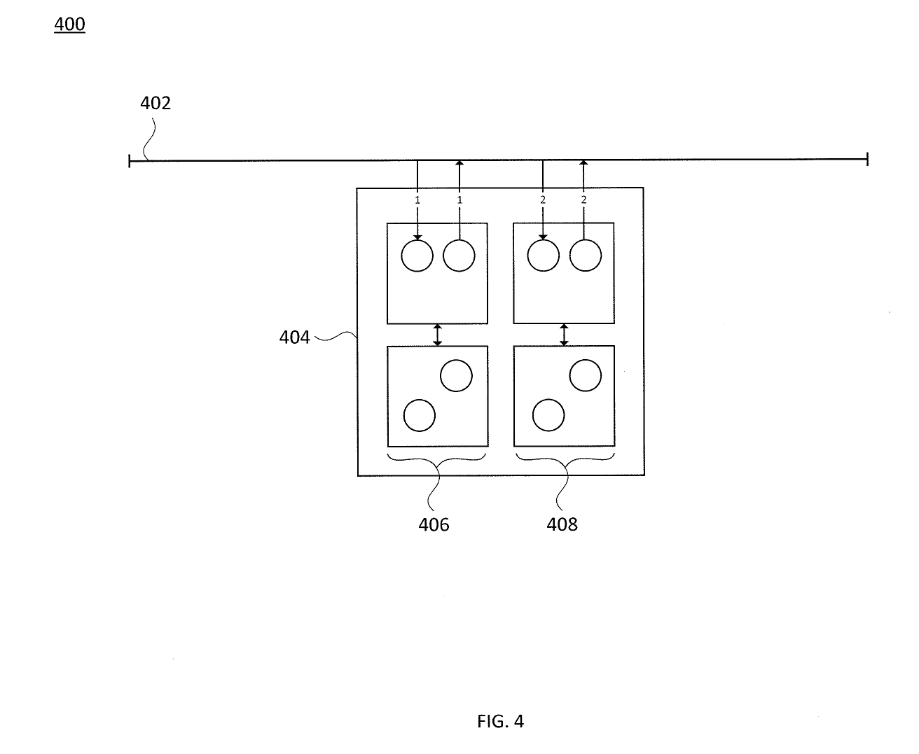

FIG. 4 illustrates an exemplary software defined networking system 400, for replacement/regeneration of software defined networking components, in accordance with some embodiments. SDN system 400 may be a part of a cloud environment that may be controlled by a cloud environment operating system, such as cloud environment OS 104 discussed above with reference to FIG. 1.

As shown in FIG. 4, SDN system 400 includes network communication interface 202, which in some instances may be the Internet, or any other suitable public or private network communication interface. The other components of SDN system 400 may communicate with one another, and with other local and remote network components (not depicted), including a cloud environment operating system, via network communication interface 402.

SDN system 400 further includes (at the point in time depicted in FIG. 4) SDN network instance 404. SDN network instance 404 may be any complete SDN, such as a complete virtual private cloud that includes inbound DNS to components (as depicted by arrows from network communication interface 402 to the components of SDN instance 404) and outbound connections through gateways (as depicted by arrows from SDN instance 404 to network communication interface 402).

SDN network instance 404 includes various subnets, gateways, routing tables, and other components. In the embodiment depicted, the various subnets, routing tables, and other components are divided into two distinct sets: a first set 406, which contains various subnets, routing tables, and other components, and a second set 408, which also contains various subnets, routing tables, and other components. In the embodiment depicted, the first set 406 and second set 408 are identical or substantially identical in network topology, as indicated by the identical arrangement of components in FIG. 4 between set 406 and set 408.

At the point in time depicted in FIG. 4, both set 406 and set 408 are in existence at the same time. However, as explained below in greater detail, subnets and other network components may be instantiated, put into service, and retired at different times from one another. For example, set 406 may initially be instantiated and in service alone, and set 408 may thereafter be instantiated and put into service, and set 406 may thereafter be retired from service. In some embodiments, individual components (e.g., subnets, gateways) within a set may be instantiated or brought into or out of service at a different time than other components in the same set.

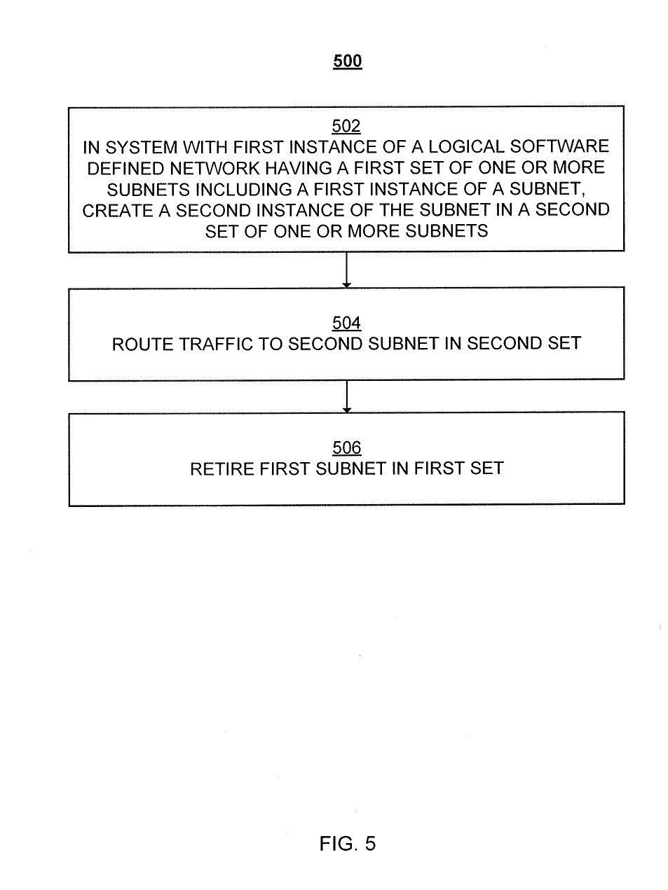

FIG. 5 is a flowchart showing method 300, which is an exemplary process for replacing or regenerating sets of network components in a software defined network. In some embodiments, method 500 may be performed at and/or by a SDN system such as SDN system 400.

At step 502, in some embodiments, in a system with a first instance of a logical software defined network having a first set of one or more subnets including a first instance of a subnet, a second instance of the subnet in a second set of one or more subnets is created. For example, a network system may include a first instance of a SDN having a first set of one or more subnets, such as SDN system 400 containing SDN 404, wherein SDN 404 contains set 406 of one or more subnets and various other network components such as gateways, routing tables, etc.

Such a system may then create a second instance of the subnet, such as SDN system 200 creating a second instance, in set 408, of the subnet whose first instance is in set 406. The second instance of the subnet may be created to replace the first instance of the subnet. It should be noted that this technique, while discussed here with reference to a first and second instance of a subnet, may be equally applicable with respect to a first and second instance of any other SDN component, such as a gateway, a routing table, a server, etc.

In some embodiments using AWS, this technique may avoid the need to create a new VPC, as the new subnet instance (or other new SDN component instance) may be created as part of a new set in the same VPC. In some embodiments performed on other cloud services aside from AWS, there may similarly not be the need for creation of a new virtual private cloud environment, as the new subnet instance (or other component instance) may be instantiated on the same virtual private cloud environment.

At step 504, in some embodiments, traffic is routed to the second subnet in the second set. In some embodiments, traffic that was previously routed to the first subnet may be redirected to the second subnet. In the example of system 400 in FIG. 4, traffic may be routed to a subnet in set 408; this traffic may be traffic that was previously routed or previously would have been routed to a subnet in set 406.

In some embodiments, production pointers using DNS may be used to route traffic to the second subnet and/or away from the first subnet. In some embodiment, other means, such as distributed service discovery over time, may be used to move traffic from the first subnet to the second subnet. In some embodiments, as discussed above with reference to FIGS. 2-3, a distributed key/value store system may be used to provide instructions and/or configuration information to users of the system or to other components of the system that traffic should be routed to the second subnet.

In some embodiments, traffic may be routed to the second subnet as soon as it is available. For example, individual subnets or other SDN components may be individually brought into operation (e.g., begin having traffic routed to them) as they are instantiated. This process may then be iterated with respect to additional subnets or additional other components of a SDN, in order to bring a new set of subnets into operation gradually. In some other embodiments, traffic may begin being routed to the second subnet at a time that is coordinated with other new instances of components being brought online, such as other components in the second set; for example, the entire second set may begin having traffic routed to it at the same or substantially the same point in time, such that the second set of subnets comes into operation all at once.

At step 506, in some embodiments, the first subnet in the first set is retired from service. In some embodiments, once all legitimate traffic has been routed to the second subnet (or once instructions or configurations have been provided to route all legitimate traffic to the second subnet), the first subnet may be retired by being removed from service entirely, such that the first instance ceases to exist.

In some embodiments, rather than removing the first subnet from service entirely, the first subnet may be repurposed within a SDN system for forensic and/or deceptive purposes, in the same or a similar manner as discussed above regarding repurposing entire instances of SDN's for forensic and/or deceptive purposes. As discussed above with respect to entire SDN instances, system administrators may similarly monitor and analyze traffic to a retired subnet or a retired set of subnets/components in an SDN in order to identify and analyze malicious traffic, in order to counter-attack intruders, or in order to identify and correct network configuration errors causing traffic to be routed to the first instance after the attempted migration of all legitimate traffic to the second instance. In some embodiments, reconfiguration of roles of SDN components, such as reconfiguring a component to serve a forensic or deceptive function rather than a primary business function, may be carried out by sending instructions to SDN components through a signaling system such as the distributed key/value store system explained above.

In some embodiments, the role of a SDN component may be changed from a primary role to a deceptive/forensic role by manipulating or changing the way in which the component interacts with a SDN at large; for example, a component that is acting in a primary business function at one point in time may be transitioned to a deceptive/forensic function as by attaching or detaching one or more network tools, changing one or more network rules regarding the component, or pointing one or more network tools at the component to monitor or introspect it. For example, one or more new containers or filesystems having tripwire or honeypot tools may be mounted onto an existing compute instance that was previously serving a business function. Similarly, the amount of network logging and intrusion detection on an instance may be increased when the instance is transitioned to a forensic role. In some embodiments, in a SDN system having a more instances of a resource than are required for the business function of the system, then the extra resources may be used for forensic or deceptive purposes; by using a notification or discovery system (e.g., a distributed key/value storage system using asynchronous messaging) to send configuration and update information to components of the SDN system, the resources that are serving forensic or deceptive functions may be constantly cycled.

As discussed above with respect to using a distributed key/value store system to alert users of a SDN to the existence and location of a new instance of the SDN or a new subnet or new set of subnets and/or components in an existing SDN, a distributed key/value store system may also be used to send configuration data and/or instructions to various components of a SDN in order to instruct the components to configure the SDN, route traffic, monitor traffic, and take other actions in order to bring new subnets into service and retire existing subnets.

In some embodiments, method 500 may be iterated or repeated one or more times, including by repeating the method in accordance with a predefined schedule, at predefined times (e.g., hourly, daily, weekly, etc.), at randomly or pseudo-randomly determined times, or in accordance with a time-to-live frequency (e.g., in which an SDN instance is assigned an amount of time after which is should be replaced). In some embodiments, regeneration may be spread across multiple network locations, with integration of resources enabled by encrypted service discovery (e.g., by a distributed key/value store system, or by any other suitable side-channel for discovering and distributing information and configuration regarding SDN system infrastructure and topology).

In some embodiments, a SDN system, such as SDN system 400, may automatically initiate method 500 in accordance with a trigger condition being met; the trigger condition may be based upon a scheduled time being reached, a time-to-live expiring, malicious network activity being detected, or any other network characteristic being measured and satisfying predetermined or dynamically/adaptively determined trigger conditions, including any or all of the trigger conditions discussed above with respect to method 300. In some embodiments, method 500 may be carried out multiple times in succession, and/or multiple times simultaneously, with respect to the same SDN, in order to regenerate and replace multiple subnets, other SDN components, or sets of subnets and/or components. In some embodiments, regeneration or replacement of an SDN component may be undertaken without receiving any indication that security of an existing instance of the SDN component has been compromised.

Topology Variation through Generational Mutation

In some embodiments of a SDN system, the techniques of regeneration of SDN's and/or SDN components (e.g., subnets) discussed above may be leveraged and built upon in order to vary the topology of SDN instances or states over time, achieving what may be termed generational mutation. For example, a SDN system may cycle through a predefined set of topologies for different states or different instances of a SDN, replacing existing network components or replacing entire networks with similar but non-identical networks or network components. By replacing networks or components with similar but non-identical counterparts, the same or similar business goals may be achieved by the modified/mutated network, but different topology and/or components of that topology may be used. In some embodiments, as explained further below, distinct and/or continuously evolving network components and network topology may frustrate certain attacks that are targeted at specific infrastructure, and complex an changing network topologies may make navigation of a SDN by an intruder difficult and dangerous for the intruder.

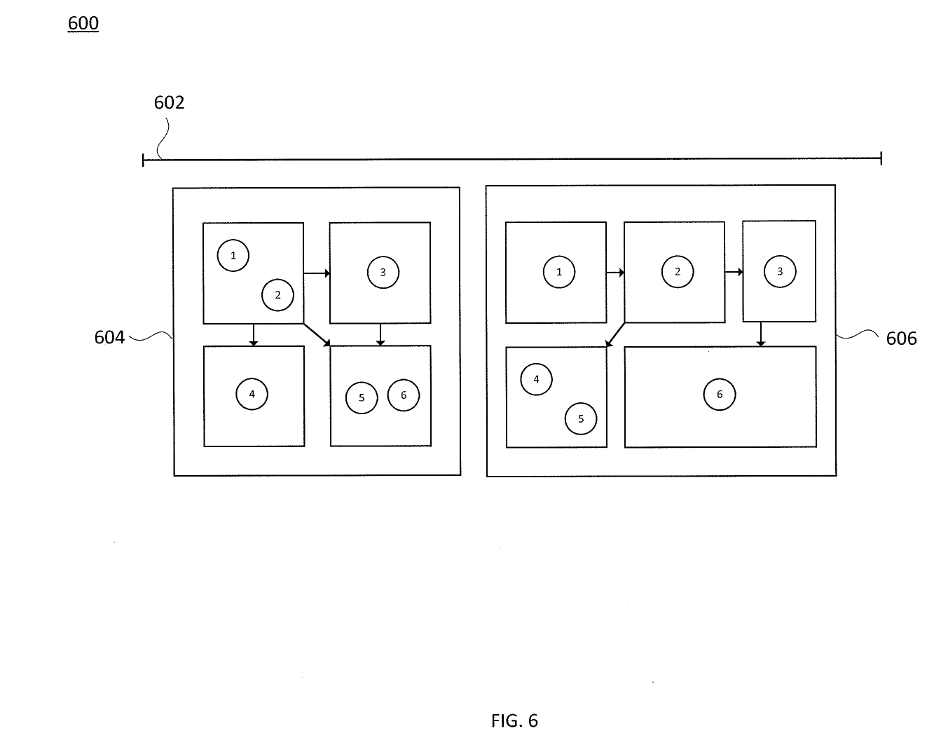

FIG. 6 illustrates an exemplary software defined networking system 600, for topology variation through generational mutation of a software defined network, in accordance with some embodiments. SDN system 600 may be a part of a cloud environment that may be controlled by a cloud environment operating system, such as cloud environment OS 104 discussed above with reference to FIG. 1.

As shown in FIG. 6, SDN system 600 includes network communication interface 602, which in some instances may be the Internet, or any other suitable public or private network communication interface. The other components of SDN system 600 may communicate with one another, and with other local and remote network components (not depicted), including a cloud environment operating system, via network communication interface 602.

SDN system 600 further includes (at the point in time depicted in FIG. 6) SDN network instance 604. SDN network instance 604 may be any complete SDN, such as a complete virtual private cloud that includes inbound DNS to components (not depicted) and outbound connections through gateways (not depicted). In the example depicted, network instance 604 has six services (numbered 1 through 6) that are arranged across four subnets. As shown, services 1 and 2 are in a first subnet, service 3 is in a second subnet, service 4 is in a fourth subnet, and services 5 and 6 are in a fourth subnet. In some embodiments, services may include compute services, storage services, gateways, routers, security groups, firewalls, access control lists, and identity and permission policies (e.g., IAM roles).

SDN system 600 further includes (at the point in time depicted in FIG. 6) SDN network instance 606. SDN network instance 606 may be any complete SDN, such as a complete virtual private cloud that includes inbound DNS to components (not depicted) and outbound connections through gateways (not depicted). In the example depicted, network instance 604 has six services (numbered 1 through 6), which may be identical or substantially identical to the services 1 through 6 included in instance 604, as discussed above. Rather than being arranged across four subnets as in instance 604, the services 1 through 6 in instance 606 are arranged across five subnets; service 1 is in a first subnet, service 2 is in a second subnet, service 3 is in a third subnet, services 4 and 5 are in a fourth subnet, and service 6 is in a fifth subnet. As shown by the arrows between subnets, in instances 604 and 606, routing tables for each instance may define routes between the subnets such that equivalent or similar capabilities may be provided by each instance, even though services may be distributed across a different subnet topology. For example, equivalent or similar capabilities may be provided by subnets that contain compute and storage resources capable of performing needed services for an application, and by routes and access connecting the necessary compute and storage resources to the other parts of the application that require access to those resources. In some embodiments, instance 606 may be understood as providing equivalent infrastructure from a functional perspective as compared to instance 604, but utilizing a distinct topology.

In some embodiments, similar techniques to those described above with respect to FIGS. 3 and 5 may be used to instantiate and bring into service new instances of SDN's having mutated topology, or to instantiate and bring into service new instance of SDN components having or creating a mutated topology.

In some embodiments of whole-cloth generational mutation of a SDN, method 300 in FIG. 3 may be implemented such that step 302 of creating a second instance of the SDN includes creating the second instance of the SDN such that it is generationally mutated from the first instance of the SDN. The generationally mutated second SDN instance may provide the same or similar functional infrastructure but with a variant topology as compared to the first instance. In the example of system 600 in FIG. 6, for example, for example, a generationally mutated instance of a SDN (e.g., instance 606) may be instantiated in its entirety. For example, in the case of AWS, a first instance of a VPC may be replaced by a second instance of the VPC, where the second instance has the same compute and storage resources, but a variant topology. In some embodiments, replacing the first VPC instance with the second VPC instance may include the creation and/or use of new authentication and access resources and credentials, such as IAM roles and/or encryption keys. In some embodiments, authentication and access resources and credentials may be rotated based on unpredictable encryption timing (e.g., random or pseudo-random timing) that may be communicated through either updated plans (e.g., a new set of instructions provided to a cloud environment operating system, the updated plan pointing to new access resources or credentials) or by signaling (e.g., transmitting new pointers on a watched key via a messaging service and/or a distributed key/value storage system). Continuing to steps 304 and 306 of method 300, in some embodiments, traffic may then be routed away from the prior instance (e.g., instance 604) to the mutated instance, and the prior instance may be retired from service.

In some embodiments of individual subnet or SDN component generational mutation, method 500 in FIG. 5 may be implemented such that step 502. The generationally mutated second subnet instance may cause the subnet or the SDN as a whole to provide the same or similar functional infrastructure, but with a variant topology as compared to the SDN when using the first instance of the subnet. A new instance of a subnet or sub-component may be considered to be a generationally mutated instance when the new instance is distinct in some manner from the previous instance, such as by leveraging different software to achieve the same business services or the same or similar technical capabilities. For example, a particular compute instance may run the NGINX web server in one generation, and then the APACHE web server in the second instance. Because many exploits are dependent upon a particular piece of software, this generational mutation of a compute instance could mitigate vulnerabilities over time by obviating exploits directed at software that is not being used by the current generation.

In some embodiments, more than one mutated subnet may be instantiated to replace a single existing subnet, or one mutated subnet may be created to replace more than one existing subnet. In the example of system 600 in FIG. 6, step 502 may be implemented to create a generationally mutated subnet by creating one or more of the subnet shown in instance 606 to replace one or more of the subnets shown in instance 604; in some embodiments, the subnets shown in instance 606 may be created in the same SDN as the subnets they are replacing. (e.g., the same VPC), rather than created in a separate SDN.

For example, the two lowermost subnets shown in instance 606 (the two subnets containing services 4 through 6 in instance 606) could be instantiated in order to replace the two lowermost subnets shown in instance 604 (the two subnets containing services 4 through 6 in instance 604). While the pair of subnets shown in FIG. 6 in instance 606 (which could be instantiated in instance 604) includes the same services as the pair of subnets shown in FIG. 6 in instance 604, the new subnets may be understood to be generationally mutated because the services are arranged according to a different topology.

Once the one or more mutated subnets or sub-components are instantiated in the SDN, method 500 may continue to steps 504 and 506, in some embodiments, by routing traffic away from the prior subnets (e.g., those shown in instance 604) to the mutated subnets, and by retiring the prior subnets from service.

In some embodiments, a SDN may be cycled through various topologies (in accordance with either method 300 or method 500 as discussed above) in accordance with a predefined schedule, at predefined times (e.g., hourly, daily, weekly, etc.), at randomly or pseudo-randomly determined times, or in accordance with a time-to-live frequency (e.g., in which an instance or generation of an SDN or component is assigned an amount of time after which is should be replaced). In some embodiments, regeneration may be spread across multiple network locations, with integration of resources enabled by encrypted service discovery (e.g., by a distributed key/value store system, or by any other suitable side-channel for discovering and distributing information and configuration regarding SDN system infrastructure and topology).

In some embodiments, a SDN system, such as SDN system 200, may automatically initiate method 300 or 500 in accordance with a trigger condition being met; the trigger condition may be based upon a scheduled time being reached, a time-to-live expiring, malicious network activity being detected, or any other network characteristic being measured and satisfying predetermined or dynamically/adaptively determined trigger conditions, including any or all of the trigger conditions discussed above with respect to method 300. In some embodiments, generational mutation of an SDN or component may be undertaken without receiving any indication that security of an existing instance of the SDN or component has been compromised.

### Algorithmic Topological Variation

In some embodiments, one or more topologies of an SDN may be designed by human network engineers and may be stored in such a manner that the network topologies may be accessed and implemented at future times. For example, a network engineer may create a library of network topologies, each representing a different generational mutation, and may configure an SDN system to cycle one or more SDN's through each of the predefined topologies according to one or more of the scheduling mechanisms discussed above. In some embodiments, the order of SDN topologies may be predefined (e.g., a cycle or loop), while in some embodiments the order of SDN topologies may be randomly or pseudo-randomly generated to select from among the predefined set of topologies. In some embodiments, algorithmic determination, including monitoring for the satisfaction or one or more trigger conditions, may influence the order in which different topologies are selected and implemented. For example, if a network detects exploits aimed at NGINX web servers, then a system may automatically implement one or more topologies that replace NGINX web servers with APACHE web servers.

In some embodiments, rather than utilizing human-designed network topologies implemented in accordance with a schedule or an algorithm, the generationally mutated network topologies may themselves be designed and generated in accordance with one or more algorithms. These algorithms may respect the business and/or operational requirements of a network and other resources, but may arrange the resources in novel topological arrangements that may not be obvious to intruders or malicious actors. As one example, a particular business system may have a web front end, and application server tier, and a database tier. In a typical SDN for such an application, these might be segregated into three tiers of subnets, with routes from A>B>C. In an obfuscated SDN topology, these three functions may still be in three tiers of subnets, but those subnets may be part of a larger graph, where the path is inobvious, but still usable with knowledge of the proper use of the graph. For example, the system might have subnets A-Z now, where A has routes to B, D, E, F, G, H, and I, all of which besides B contain trip wires, honeypots, or dead ends.

One or more algorithms that may further be used to determine timing of regeneration and mutation as well as design of topologies may consider both information known at the time of authorship and dynamic information from a run-time environment. Because capabilities for regenerating and mutating infrastructure over time can be expressed as commands that may be compiled and executed by a cloud environment operating system, entire patterns of deployment, regeneration, deception and obfuscation can be built into high-order functions. For example, certain methods of compiling commands and executing them by a cloud environment operating system are disclosed in U.S. patent application Ser. No. 15/215,409, filed Jul. 20, 2016, titled “SYSTEM AND METHOD FOR BUILDING, OPTIMIZING, AND ENFORCING INFRASTRUCTURE ON A CLOUD BASED COMPUTING ENVIRONMENT,” the entirety of which is hereby incorporated by reference.

While, in human-designed networks, it may be desirable to and necessary to create topologies that are understandable and navigable, these constraints may not apply in algorithmically generated topologies. That is, in algorithmically generated topologies, network components may be arranged in such a manner as to make the network efficiently navigable only by informed actors.

If the required connectivity of resources is known, algorithms can be used to generate highly variable network topologies with obfuscated routes, dead ends, and large numbers of honey-pots and trip-wires and other deceptive resources. A complex SDN topology can also be created such that, from any given machine that may be compromised, the vast majority of components visible from the compromised machine may not actually be part of the primary (e.g., non-deceptive) business functionality of the system. In such a system in which deceptive components are further configured to detect intrusion by malicious actors who access them, the probability of detecting malicious actors may be greatly increased, while the probability of malicious actors successfully accessing primary (e.g., non-deceptive) function components of the system may be greatly decreased. Thus, creating complex SDN topologies that are not easily navigable by non-informed actors may allow for effective obfuscation and deception, thwarting and frustrating malicious actors, and creating a dangerous environment for malicious actors.

Legitimate users of such a SDN with a complex algorithmically-generated topology discussed above may remain constantly informed of the most up-to-date information regarding the SDN topology, including the instantiation of new components, the retirement of old components, the transitioning of roles of components, and changing credentials and keys required for legitimate communication. In some embodiments, legitimate users may maintain constant access to this information required to navigate a topologically complex SDN by using a distributed key/value store system in order to read the most up-to-date information from a central notification topic known to and accessibly by legitimate users. Meanwhile, because SDNs are not physically routed based on logical subnets, there may be little or no performance penalty to introducing highly convoluted routes to legitimate resources.

### Isolation

Because the creation and operation of the resources in cloud computing may be fully automated, human access to administrative functions of the resources may be removed, and the administrative tools otherwise required for humans to maintain the resources may be removed. For example, no-touch compute resources may not require access for administration, so most user-space tools may be removed. In fully automated “immutable” infrastructure environments, the compute resources that provide particular services may not need most of their administrative tooling, as they are not manually manipulated. These same administrative tools may also be used by bad actors when a compute resource is exploited, so removing the tools may lower the attack surface of the compute resources.

Similar isolation concepts may be applied to other cloud computing and SDN components. For example, with regenerative patterns, most network access may be eliminated. Just as compute resources in fully automated environments may not need user space tools, SDN's may not need most or all administrative functions (e.g., command-line-interface access, application program interface access, access to changing route tables, access control list access, security group access, etc.) in automated regenerative SDN's. Combining these isolation principles with the regeneration and generational mutation concepts discussed above may create a constantly moving and isolated collection of resources in SDN systems, significantly raising the difficulty of attacking the system as a whole.

The techniques and systems disclosed herein may be combined with one another in additional combinations as those laid out in the specific examples herein. For example, the techniques discussed with respect to regenerating or mutating SDN's may be similarly applicable to regenerating and mutating SDN components (e.g., subnets), and vice-versa.

What is claimed is:

1. A method for replacing one or more instances in a software defined network system, the method comprising:
in a software defined network system having a first instance of a software defined network, in response to one or more trigger conditions being satisfied:
instantiating a second instance of the software defined network;
transmitting instructions to one or more components of the software defined network system to route traffic to infrastructure of the second instance of the software defined network; and
retiring the first instance of the logical software defined network from service.

2. The method of claim 1, wherein the second instance of the software defined network comprises a same compute and storage infrastructure as the first instance.

3. The method of claim 1, wherein the second instance of the software defined network comprises a same topology as the first instance.

4. The method of claim 1, wherein the second instance of the software defined network comprises distinct compute and storage infrastructure from the first instance, wherein the distinct compute and storage infrastructure are configured to fulfill an equivalent functional requirement as the first instance.

5. The method of claim 4, wherein the distinct compute and storage infrastructure are selected so as to be resistant to exploits targeting infrastructure of the first instance.

6. The method of claim 1, wherein the second instance of the software defined network comprises a distinct topology from the first instance, wherein the distinct topology is configured to fulfill an equivalent functional requirement as the first instance.

7. The method of claim 6, wherein the distinct topology is algorithmically generated to comprise one or more of obfuscated routes, dead ends, and deceptive resources.

8. The method of claim 6, wherein the distinct topology is algorithmically generated such that, from any single exploitable machine in the software defined network system, the majority of visible resources are deceptive resources.

9. The method of claim 1, wherein transmitting instructions to one or more components of the software defined network system comprises transmitting instructions to authorized end users of the software defined network system.

10. The method of claim 1, wherein transmitting instructions to one or more components of the software defined network system comprises transmitting instructions to a second network of the software defined network system.

11. The method of claim 1, wherein transmitting instructions to one or more components of the software defined network system comprises distributing the instructions via a distributed key/value store system.

12. The method of claim 11, wherein the distributed key/value store system uses one or more asynchronous messaging protocols.

13. The method of claim 1, wherein retiring the first instance comprises destroying the first instance.

14. The method of claim 1, wherein retiring the first instance comprises configuring the first instance to serve purpose other than a primary business function.

15. The method of claim 14, wherein the purpose other than a primary business function is one of a deceptive use and a forensic use.

16. The method of claim 1, wherein retiring the first instance comprises transmitting second instructions to one or more components of the software defined network system indicating that the first instance is being retired.

17. The method of claim 16, wherein transmitting the second instructions comprises distributing the instructions via a distributed key/value store system.

18. The method of claim 16, wherein the second instructions comprise an indication that the first instance should be treated by other components of the software defined network system as one of a deceptive resource and a forensic resource.

19. The method of claim 1, wherein the one or more trigger conditions comprises a predefined time being reached.

20. The method of claim 1, wherein the one or more trigger conditions comprises a time-to-live of the first instance of the software defined network expiring.

21. The method of claim 1, wherein the one or more trigger conditions comprises a randomly-generated time-period expiring.

22. The method of claim 1, wherein the one or more trigger conditions are satisfied without receiving any indication that the first instance of the software defined network has been compromised.

23. The method of claim 1, further comprising disabling one or more administrative functions for the software defined network system.

24. A non-transitory computer-readable storage medium storing instructions that, when executed by a processor of a software defined network system having a first instance of a software defined network, cause the system to:
in response to one or more trigger conditions being satisfied:
instantiate a second instance of the software defined network;
transmit instructions to one or more components of the software defined network system to route traffic to infrastructure of the second instance of the software defined network; and
retire the first instance of the logical software defined network from service.

25. A software defined network system comprising:
a first instance of a software defined network;
a processor; and
memory storing instructions that, when executed by the processor, cause the system to:
in response to one or more trigger conditions being satisfied:
instantiate a second instance of the software defined network;
transmit instructions to one or more components of the software defined network system to route traffic to infrastructure of the second instance of the software defined network; and
retire the first instance of the logical software defined network from service.

26. A method for replacing one or more instances in a software defined network system, the method comprising:
in a software defined network having a first instance of a network component, in response to one or more trigger conditions being satisfied:
instantiating a second instance of the first network component;
transmitting instructions to one or more components of the software defined network system to route traffic to the second instance of the network component; and
retiring the first instance of the network component from service.

27. The method of claim 24, wherein the network component is a subnet.

28. The method of claim 1, wherein the second instance of the network component comprises a same compute and storage infrastructure as the first instance.

29. The method of claim 1, wherein the second instance of the network component comprises a same topology as the first instance.

30. The method of claim 1, wherein the second instance of the network component comprises distinct compute and storage infrastructure from the first instance, wherein the distinct compute and storage infrastructure are configured to fulfill an equivalent functional requirement as the first instance.

31. The method of claim 4, wherein the distinct compute and storage infrastructure are selected so as to be resistant to exploits targeting infrastructure of the first instance.

32. The method of claim 1, wherein the second instance of the network component comprises a distinct topology from the first instance, wherein the distinct topology is configured to fulfill an equivalent functional requirement as the first instance.

33. The method of claim 6, wherein the distinct topology is algorithmically generated to comprise one or more of obfuscated routes, dead ends, and deceptive resources.

34. The method of claim 6, wherein the distinct topology is algorithmically generated such that, from any single exploitable machine in the software defined network system, the majority of visible resources are deceptive resources.

35. The method of claim 1, wherein transmitting instructions to one or more components of the software defined network system comprises transmitting instructions to authorized end users of the software defined network.

36. The method of claim 1, wherein transmitting instructions to one or more components of the software defined network system comprises transmitting instructions to a second network component of the software defined network.

37. The method of claim 1, wherein transmitting instructions to one or more components of the software defined network system comprises distributing the instructions via a distributed key/value store system.

38. The method of claim 11, wherein the distributed key/value store system uses one or more asynchronous messaging protocols.

39. The method of claim 1, wherein retiring the first instance comprises destroying the first instance.

40. The method of claim 1, wherein retiring the first instance comprises configuring the first instance to serve purpose other than a primary business function.

41. The method of claim 14, wherein the purpose other than a primary business function is one of a deceptive use and a forensic use.

42. The method of claim 1, wherein retiring the first instance comprises transmitting second instructions to one or more components of the software defined network system indicating that the first instance is being retired.

43. The method of claim 16, wherein transmitting the second instructions comprises distributing the instructions via a distributed key/value store system.

44. The method of claim 16, wherein the second instructions comprise an indication that the first instance should be treated by other components of the software defined network system as one of a deceptive resource and a forensic resource.

45. The method of claim 1, wherein the one or more trigger conditions comprises a predefined time being reached.

46. The method of claim 1, wherein the one or more trigger conditions comprises a time-to-live of the first instance of the software defined network expiring.

47. The method of claim 1, wherein the one or more trigger conditions comprises a randomly-generated time-period expiring.

48. The method of claim 1, wherein the one or more trigger conditions are satisfied without receiving any indication that the first instance of the network component has been compromised.

49. The method of claim 1, further comprising disabling one or more administrative functions for the software defined network system.

50. A non-transitory computer-readable storage medium storing instructions that, when executed by a processor of a software defined network system having a first instance of a network component, cause the system to:
in response to one or more trigger conditions being satisfied:
instantiate a second instance of the first network component;
transmit instructions to one or more components of the software defined network system to route traffic to the second instance of the network component; and
retire the first instance of the network component from service.

51. A software defined network system comprising:
a first instance of a network component;
a processor; and
memory storing instructions that, when executed by the processor, cause the system to:
in response to one or more trigger conditions being satisfied:
instantiate a second instance of the first network component;
transmit instructions to one or more components of the software defined network system to route traffic to the second instance of the network component; and
retire the first instance of the network component from service.
